(19) United States
(12) Patent Application Publication
(10) Pub. No.: US 2005/0266162 A1
(43) Pub. Date: Dec. 1, 2005

(54) Carbon nanotube stripping solutions and methods

(76) Inventors: Jiazhong Luo, Acton, MA (US); Philip Wallis, Barrington, RI (US); David J. Arthur, Norwood, MA (US); Paul J. Glatkowski, Littletown, MA (US)

Correspondence Address: POWELL GOLDSTEIN LLP;INTELLECTUAL PROPERTY GROUP, 901 NEW YORK AVENUE, N.W., THIRD FLOOR, WASHINGTON, DC, 20001, US

(21) Appl. No.: 11/079,012

(22) Filed: Mar. 14, 2005

Related U.S. Application Data
(60) Provisional application No. 60/552,211, filed on Mar. 12, 2004.

(51) Int. Cl. B05D 1/12

(52) U.S. Cl. 427/180

(57) ABSTRACT

The invention is directed to compositions and methods for forming conductive patterned coatings of carbon nanotubes. Patterns are electrically conductive coatings/films made by exploiting self patterning nanostructures composed of electrically conductive materials. The resulting layer is suitable for conducting electricity in applications where a transparent electrode is required. Typical applications include, but are not limited to; LC displays, touch screens, EMI shielding windows, and architectural windows. Films may be highly transparent. In one embodiment, carbon nanotubes are applied to an insulating substrate to form an electrically conductive network of nanotubes with controlled porosity in the network. The open area between the networks of nanotubes, increases the optical transparency in the visible spectrum while the continuous nanotube phase provides electrical conductivity across the entire surface or patterned area. Through the controlled application of this self assembled network of nanotubes by means of printing or spraying, patterned areas can be formed to function as electrodes in devices. The use of printing technology to form these electrodes obviates the need for more expensive process such as vacuum deposition and photolithography typically employed today during the formation of ITO coatings.

### REFERENCE TO RELATED APPLICATIONS

This application claims priority to U.S. Provisional Patent Application No. 60/552,211 entitled “Carbon Nanotube Coating Stripping Solutions and Ink Dispersion Containing Small Molecular Additives,” filed Mar. 12, 2004, the entirety of which is hereby incorporated by reference.

### BACKGROUND

1. Field of the Invention

The invention is directed to methods for selective removal of carbon nanotubes from coated surfaces and films. Selective removal of the nanotubes results in formation of patterns. The invention is also directed to carbon nanotube patterned films and materials.

2. Description of the Background

Carbon nanotubes are the most recent addition to the growing members of the carbon family of molecular structures. Carbon nanotubes can be viewed as a graphite sheet rolled up into a nanoscale tube form to produce the so-called single-wall carbon nanotubes (SWNT) Harris, P. F. “Carbon Nanotubes and Related Structures: New Materials for the Twenty-first Century”, Cambridge University Press: Cambridge, 1999. There may be additional graphene tubes around the core of a SWNT to form multi-wall carbon nanotubes (MWNT). These elongated nanotubes have a diameter in the range from few angstroms to tens of nanometers and a length of several micrometers up to millimeters. Both ends of the tubes may be capped with fullerene-like structures such as pentagons.

Carbon nanotubes comprises straight and/or bent multi-walled nanotubes (MWNT), straight and/or bent double-walled nanotubes (DWNT), or straight and/or bent single-walled nanotubes (SWNT), and combinations and mixtures thereof. CNT may also include various compositions of these nanotube forms and common by-products contained in nanotube preparations such as described in U.S. Pat. No. 6,333,016 and WO 01/92381. Carbon nanotubes may also be modified chemically to incorporate chemical agents or compounds, or physically to create effective and useful molecular orientations (see U.S. Pat. No. 6,265,466), or to adjust the physical structure of the nanotubes.

SWNTs can be formed by a number of techniques, such as laser ablation of a carbon target, decomposing a hydrocarbon, and setting up an arc between two graphite electrodes. For example, U.S. Pat. No. 5,424,054 to Bethune et al. describes a process for producing single-walled carbon nanotubes by contacting carbon vapor with cobalt catalyst. Carbon vapor is produced by electric arc heating of solid carbon, which can be amorphous carbon, graphite, activated or decolorizing carbon or mixtures thereof. Other techniques of carbon heating are discussed, such as laser heating, electron beam heating and RF induction heating. Smalley (Guo, T., Nikoleev, P., Thess, A., Colbert, D. T., and Smally, R. E., Chem. Phys. Lett. 243: 1-12 (1995)) describes a method of producing single-walled carbon nanotubes, wherein graphite rods and a transition metal are simultaneously vaporized by a high-temperature laser. Smalley (Thess, A., Lee, R., Nikolaev, P., Dai, H., Petit, P., Robert, J., Xu, C., Lee, Y. H., Kim, S. G., Rinzler, A. G., Colbert, D. T., Scuseria, G. E., Tonarek, D., Fischer, J. E., and Smalley, R. E., Science, 273: 483-487 (1996)) also describes a process for production of single-walled carbon nanotubes in which a graphite rod containing a small amount of transition metal is laser vaporized in an oven at about 1,200° C. Single-wall nanotubes were reported to be produced in yields of more than 70%. U.S. Pat. No. 6,221,330 discloses methods of producing single-walled carbon nanotubes which employs gaseous carbon feedstocks and unsupported catalysts.

Carbon nanotubes have many well known applications (R. Saito, G. Dresselhaus, M. S. Dresselhaus, “Physical Properties of Carbon Nanotubes,” Imperial College Press, London U.K. 1998, or A. Zettl “Non-Carbon Nanotubes” Advanced Materials, 8, p. 443, 1996). Carbon nanotubes can exhibit semiconducting or metallic behavior (Dai, L.; Mau, A. W. M. Adv. Mater. 2001, 13, 899). They also possess a high surface area (400 m2/g for nanotube “paper”) (Niu, C.; Sichel, E. K.; Hoch, R.; Moy, D.; Tennent, H. “High power electrochemical capacitors based on carbon nanotube electrodes”, Appl. Phys. Lett. 1997, 70, 1480-1482), high electrical conductivity (5000 S/cm) (Dresselhaus, M. Phys. World 1996, 9, 18), high thermal conductivity (6000 W/mK) and stability (stable up to 2800° C. in vacuum) (Collins, P. G.; Avouris, P. “Nanotubes for electronics”, Sci. Am. 2000, December 62-69) and good mechanical properties (tensile strength 45 billion pascals).

Films made of carbon nanotubes are known to have surface resistances as low as 102 ohms/square. U.S. Pat. No. 5,853,877, entitled “Method for Disentangling Hollow Carbon Microfibers, Electrically Conductive Transparent Carbon Microfibers Aggregation Film and Coating for Forming Such Film,” describes formation of conductive carbon nanotube films. U.S. Pat. No. 6,221,330, entitled “Processing for Producing Single Wall Nanotubes Using Unsupported Metal Catalysts,” generally describes production of carbon nanotubes for forming conductive films. However, there has been no report in the art on a method for patterning carbon nanotube-containing films.

Coatings comprising carbon nanotubes, such as carbon nanotube-containing films, have been previously described (see U.S. patent application No. 10/105,623). Such films may have a surface resistance as low as 102 ohms/square and a total light transmittance as high as 95%. The content of carbon nanotubes in these films may be as high as 50%. Carbon nanotubes may also be deposited on a transparent plastic film to form a transparent conductive coating.

Carbon nanotubes deposited on a surface as a thin coating or film can function as electrical conductors or electrodes, catalytic sites, sensors to detect chemicals, energy, motion or contact (as in touch screens); and other functions which exploit the unique properties of this new form of carbon material. However, to utilize thin coating of nanotubes in most applications, the coating of nanotubes must be formed as patterns or circuits defining an active area of nanotubes and separating that area from one or more inactive areas.

For a coating of nanotubes to function as an electrode in a resistive-type touch screen, the electrode must be patterned on an electrically insulating substrate. For example, a polymer film such as polyethylene terephthalate PET, can define parts of the nanotube coating that forms an electrically conductive circuit and switch. That coating then responds to the operator's touch when pressed against a second electrode.

Most commercially produced, transparent electrodes are made from metal or metal oxide coatings applied to an optically transparent substrate by, for example, vacuum deposition, chemical vapor deposition, chemical bath deposition, sputtering, evaporation, pulsed vapor deposition, sol-gel methods, electroplating or spray pyrolysis. If desired, these coatings can be patterned with costly photolithographic techniques. This process is difficult and expensive. Scaling up production to cover large areas with electrodes can be almost prohibitively. Further, because coatings are based on a rigid metal oxide, flexible applications which would otherwise be possible with substrates of plastic displays, plastic solar voltaic and wearable electrical circuitry are also not possible.

Thus, there is a need for scalable process for patterning electrically conductive CNT coatings that may be optically transparent and/or flexible.

### SUMMARY OF THE INVENTION

The present invention overcomes problems and disadvantages associated with current strategies and designs and provides compositions and methods for selectively removing carbon nanotubes from a surface. The invention is further directed to films, coating and other materials made by these methods.

thereby forming patterned coatings, films and other surface coverings. Removal of CNT from the surface using a formulation designed to release only the CNT without.

One embodiment of the invention is directed to methods for removing carbon nanotubes from a substrate, preferably without damaging or otherwise altering the surface. The method comprises applying a stripping solution to a CNT coated substrate, applying ultrasonic energy by emersion of the substrate, and removing and rinsing the surface with fluids such as, but not limited to, water, alcohols, acids, bases and combinations thereof, and preferably clear fluids, to release the CNT from the substrate. The resulting material has a carbon nanotube-patterned surface.

Another embodiment of the invention is directed to methods for patterning a carbon nanotube coating. The method comprises providing a solution of carbon nanotubes, applying the solution to a substrate to form a film of consolidated carbon nanotubes on the substrate, impregnating the carbon nanotube film selectively with a binder, and removing at least a part of the carbon nanotube film that is not impregnated with binder from the substrate with a solvent to release only exposed CNT from the surface. Preferably, release is encouraged by exposure to mechanical agitation, such as ultrasonic agitation or spraying.

Another embodiment of the invention is directed to methods for removing a carbon nanotube coating. These methods comprise providing a solution of carbon nanotubes, applying the solution to a substrate to form a film of consolidated carbon nanotubes on the substrate, impregnating the carbon nanotube film with a photoresist, projecting a predetermined pattern onto the carbon nanotube film impregnated with the photoresist to secure carbon nanotubes to the substrate, and removing unsecured carbon nanotubes that project from the substrate.

Another embodiment of the invention comprises coatings, films and other articles, coated by a method of the invention.

Other embodiments and advantages of the invention are set forth, in part, in the following description and, in part, may be obvious from this description, or may be learned from the practice of the invention.

### DESCRIPTION OF THE FIGURES

FIG. 1A solubility or CNT striping map.

FIG. 2 Carbon nanotube patterning on films: (A) Screen printed PVDF on CNT/PET; (B) photo lithographed dry film resist on CNT/PET; and (C) Ink jetted polyethylene was (hot melt ink) on CNT.

FIG. 3 Phase diagram for the basic composition of urea containing solution for selective stripping.

### DESCRIPTION OF THE INVENTION

Conductive coatings are most often manufactured in the form of uniform sheets or patterned circuits. For most applications, carbon nanotubes (CNTs) can be substituted for other conductive materials, such as metal oxides. These CNT-based conductive coatings can be transparent and, unlike metal oxide-based coatings, can also be flexible. However, where conductivity needs to be patterned, the only process to create desired patterns has been to lay the CNTs into a pattern during manufacture. No method exists to efficiently remove CNTs from undesired portions to create patterns after manufacture. For such a process to be successful, CNTs would need to be efficiently removed from selected areas of the substrate and not others, to separate the conductive paths from each other. Further, the stripping process would need to be fast and highly selective, preferably using environmentally friendly materials, and the process should not remove or unnecessarily disturb the desired CNT coated areas.

CNT coatings have high adhesion to the substrates such as PET film and other polymeric substrates. These coatings cannot be peeled off by scotch tape or washed off with conventional solvents, even after exposure to sonic energy. Adhesion is likely due to mechanical/physical adhesion, and weak polar and Van der-Waals attraction between the CNT and the substrate materials. CNTs form a continuous network on the surface and incorporates and interacts with surface morphology of the substrate. For example, using scotch tapes or exposure to high vacuum failed to strip CNT off the PET substrates after being applied through regular coating methods such as spray coating. Simple solvents such as water and alcohols are known to disperse functionalized carbon nanotubes, but will not remove carbon nanotubes from a surface even with the addition of ultrasonic energy. Although mechanical abrasion combined with solvents can sometimes remove CNTs from a polymeric surface, the resulting surface is sufficiently damaged so as to be of no further use when detailed patterns are required.

It was surprisingly discovered that there are particular combinations of chemicals that will strip off CNTs from a substrate quickly and selectively, and with no or minimal damage to immediately adjacent CNT-coated surfaces. This invention provides stripping solution compositions and methods for applying these compositions to form patterned CNT coated films and materials. Further, these stripping products and process are useful in fabrication of CNT-based circuits, detailed CNT patterning and refinement of previously patterned CNT films, as well as clean-up and recycling of CNT coating products. Thus, the invention generally relates to methods for removing CNT from films and coatings, and to carbon nanotube films and coatings treated with these methods. In particular, the invention relates to methods of selective removal of CNT from conductive, transparent and flexible films and coatings.

One embodiment of the invention is directed to methods for removing carbon nanotubes from a substrate, preferably without damaging or otherwise altering a surface. The method comprises applying a stripping solution to a CNT coated substrate, applying ultrasonic energy by emersion of the substrate, and removing and rinsing the surface with clear fluids to release the CNT from the substrate. The resulting material has a carbon nanotube-patterned surface.

Another embodiment of the invention is directed to methods for patterning a carbon nanotube coating. The method comprises providing a solution of carbon nanotubes, applying the solution to a substrate to form a film of consolidated carbon nanotubes on the substrate, impregnating the carbon nanotube film selectively with a binder, and removing at least a part of the carbon nanotube film that is not impregnated with binder from the substrate with a solvent to release only exposed CNT from the surface. Preferably, release is encouraged by exposure to mechanical agitation, such as ultrasonic agitation or vibration, or fluid spraying.

Another embodiment of the invention is directed to methods for removing a carbon nanotube coating. These methods comprise providing a solution of carbon nanotubes, applying the solution to a substrate to form a film of consolidated carbon nanotubes on the substrate, impregnating the carbon nanotube film with a photoresist, projecting a predetermined pattern onto the carbon nanotube film impregnated with the photoresist to secure carbon nanotubes to the substrate, and removing unsecured carbon nanotubes that project from the substrate. Photoresists are well known and commercially available and include, but are not limited to, UV-curable chemicals, water-curable chemicals, radiation-curable chemicals and combinations thereof (Nazdar.com; Syunko; Tra-con; Borden Chemical; Shipley). Some, most, substantially all (i.e. within desired detection limits), and all carbon nanotubes may be removed.

Another embodiment of the invention comprises coatings, films and other articles, coated by a method of the invention.

SWNTs are very flexible and aggregate to form bundles of tubes called ropes and eventually snakes (which comprise aggregates of ropes). The formation of SWNT ropes and snakes in the coating or film allows the conductivity to be very high, while loading to be very low, and results in a good transparency and low haze. Such films provide excellent conductivity and transparency at relatively low loading of nanotubes. Nanotubes are present in the films at about 0.001% to about 50%, or from about 0.1% to about 30%, or from about 2% to about 25%, or from about 5% to about 15%. Percents may be based on weight or volume. Preferably, the nanotubes are present in film from about 0.01% to about 10% for good transparency and low haze. Layers can have a surface resistance in the range of about 10-2 to about 1012 Ohms/square, preferably about 102 to about 1012 Ohms/square, more preferably about 103 to about 1010 Ohms/square, and even more preferably about 105 to about 109 Ohms/square. Accordingly, the layer of nanotubes can provide adequate electrostatic discharge protection within this range. The instant films also have volume resistivity in the range of about 10-2 Ohms-cm to about 1010 Ohms-cm. Surface and volume resistivities are determined as defined in ASTM D4496-87 and ASTM D257-99.

The layer may be easily formed and applied to a substrate as a fluid dispersion or suspension of nanotubes alone or in solvents such as, for example, acetone, water, ethers, alcohols (e.g. ethanol, isopropanol), gasses, gels, and combinations and mixtures thereof. Solvent can be selectively removed by conventional processes such as air drying, heating or reduced pressure. The layer may be applied by other known processes including, but not limited to, processes such as spraying, dip coating, spin coating, knife coating, kiss coating, gravure coating, screen printing, ink jet printing, pad printing, other types of printing, roll coating or combinations thereof.

The instant films may be in a number of different forms including, but not limited to, a solid film, a partial film, a foam, a gel, a semi-solid, a powder, a fluid, or combinations thereof. In a preferred embodiment, nanotube films can themselves be over-coated with a polymeric material. These novel laminates or multi-layered structures comprise films of nanotubes over coated with another coating of, for example, an inorganic or organic polymeric material. Laminates can be easily formed based on the these procedures and are highly effective for distributing or transporting electrical charge. Layers may be conductive, such as tin-indium mixed oxide (ITO), antimony-tin mixed oxide (ATO), fluorine-doped tin oxide (FTO), aluminum-doped zinc oxide (FZO) layer, or provide UV absorbance, such as a zinc oxide (ZnO) layer, or a doped oxide layer, or a hard coat such as a silicon coat. In this way, each layer may provide a separate and distinct characteristic.

In a preferred embodiment, the nanotubes are oriented on a molecular level by exposing the films to a shearing, stretching, elongating step or the like. Such steps include, but are not limited to, conventional polymer processing methodology. Shearing-type processing refers to the use of force to induce flow or shear into the film, forcing a spacing, alignment, reorientation or disentangling of the nanotubes from each other greater than that achieved for nanotubes simply formulated either by themselves or in admixture with polymeric materials. Oriented nanotubes are disclosed in U.S. Pat. No. 6,265,466. Disentanglement can be achieved by extrusion techniques, application of pressure more or less parallel to a surface of the composite, or application and differential force to different surfaces thereof, e.g., by shearing treatment by pulling of an extruded plaque at a variable but controlled rate to control the amount of shear and elongation applied to the extruded plaque. This orientation results in superior properties of the film, e.g., enhanced electromagnetic (EM) shielding.

Circuits of electrically conductive material can be achieved by any of a number of conventional methods known in the field. Circuits can be created to maximize conductivity, surface or volume resistivity, or another physical parameter, between conductive materials, between layers or across a surface. Useful circuits include, but are not limited to, integrated circuit patterns, patterns to create a polarizing layer (or plurality of layers), and any desired electrical connection. Circuits may be created to maximize contact with other electrodes without sacrificing transparency.

The consolidated carbon nanotubes dried on a substrate have a remarkably strong adhesion to a surface of the substrate without any other ingredient such as a binder. Accordingly, the device intermediate, i.e., the substrate having the consolidated carbon nanotubes, is compatible with many existing device processing techniques. Yet, the adhesion is weak enough to be broken by fairly moderate disturbance. Also, carbon nanotubes consolidated on the substrate have a network structure that has a large amount of open porosity. Accordingly, a material that has a viscosity, low enough to penetrate into the open pores, may be applied on the substrate so that the open pores of the consolidated carbon nanotubes are filled with the material.

Microscopic observation of the consolidated carbon nanotubes on the substrate, prior to application of the resin, showed that the network structure appears a ropes of carbon nanotubes, which form the frame of the network structure. This structure provides the low electrical resistance and the high light transmittance at the same time, since the frame of the ropes can carry the majority of conduction. Also, the relatively large openings between ropes allows penetration of resin applied on the carbon nanotubes.

There are different approaches to forming a patterned carbon nanotube film relying on these features. For example, a carbon nanotube film may first be formed on the entire surface of a substrate. Since the consolidated carbon nanotubes on the substrate can take in various materials as part of the network structure, chemical agents for patterning may be introduced to the entire portion of the consolidated film or a selected portion of the film. Further, a binder dissolved in a solvent may be applied to the consolidated, carbon nanotube film according to a predetermined pattern. Application of the binder may be performed by any conventional methods including, but not limited to, but preferably, screen printing, ink jetting, gravure roll printing and combinations thereof. After drying the solvent, the binder remains in the network and reinforces the portion of the carbon nanotube film impregnated with binder solution. By rinsing the substrate having carbon nanotubes thereon with water or solvent that does not dissolves the binder, the part of the carbon nanotubes that are not reinforced by the binder easily comes off the substrate, while the reinforced portion of the carbon nanotube film remains intact. The substrate may be flexible or rigid, and may be made of a transparent material or a light-blocking material. For a transparent electrode application, typically a transparent inorganic glass plate is the substrate, although a transparent flexible polymer film may also be used. The substrate may also be a silicon substrate when the carbon nanotube wiring is part of integrated circuit. Furthermore, insulating layer may be formed on the carbon nanotube wiring as a protection layer. Additional carbon nanotube wiring may be formed on the insulating layer protecting the first carbon nanotube wiring to form a multi-layered wiring structure.

Rather than applying binder to the selected portion of the carbon nanotube film, a photoresist may be applied to the entire carbon nanotube film. Application of the photoresist may be performed by any conventional methods including, but not limited to, but preferably, spin coating. Once the photoresist penetrates into the network structure of the consolidated carbon nanotubes, this device intermediate may be compatible with any conventional photolithographic processing step. For example, a predetermined pattern of a reticle is projected onto the carbon nanotube film impregnated with the photoresist. Depending on the type of the photoresist used, the portion of the carbon nanotube film irradiated by light or the portion of the film not irradiated is removed in the subsequent process. The wiring pattern of the reticle is transferred onto the carbon nanotube film. In comparison to the binder patterning method, this method offers finer patterning of the carbon nanotube film, and may be more compatible with the existing silicon-based device manufacturing methods. Most any substrate may be used as the substrate for this manufacturing method. An insulating layer may be formed over the patterned carbon nanotube film, and a multi-layered carbon nanotube wiring may also be formed.

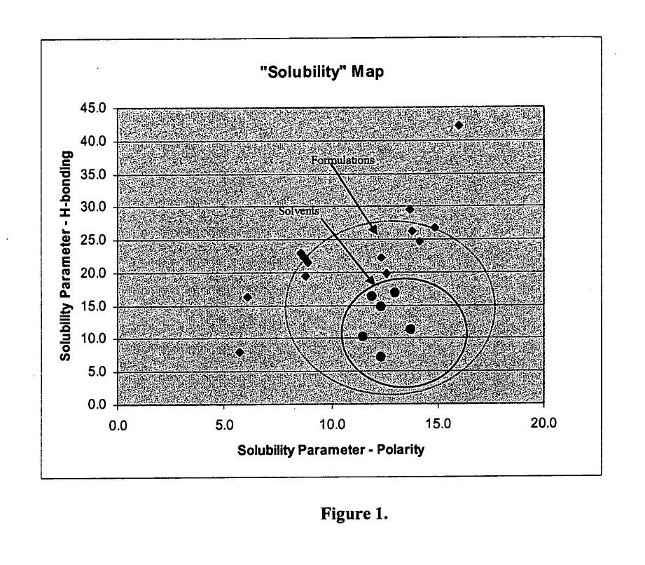

Based on results from testing, a solubility map or stripping map was constructed (FIG. 1), which provided solubility parameters for the portions of polarity and hydrogen bonding for different solvents. The area in the smaller circle shows the solvents which are capable of removing CNT on PET substrates very quickly. When using additives such as surfactants and amines, the area is expanded into a larger area as demonstrated in the larger circle with dotted lines and define an operation space.

Solvent

In general, a solvent of the invention is defined from the solubility or stripping map. Solvents can also be empirically determined by their ability to strip off unwanted CNTs while not attacking needed CNTs and their protection layer such as a binder or polymer coating. Solvents may also be chemicals having one or more chemical groups such as amide (NH—CO—) and amine (primary —NH2, secondary —NH—, tertiary —N═), and have a certain range of solubility parameters. Preferred approximate ranges include polarity solubility parameter (8-16), hydrogen bonding solubility parameter (5-20), and a total solubility parameter (20-30). Solvents of the invention include, but are not limited to, dimethyl acetamide (DMAC or DMA); dimethyl formamide (DMF) and N-methyl pyrilidone (NMP).

Solvent Mixing

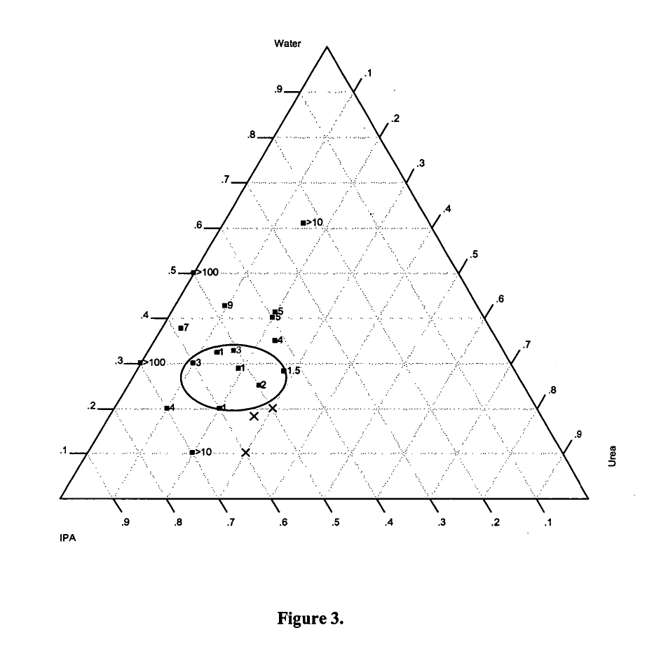

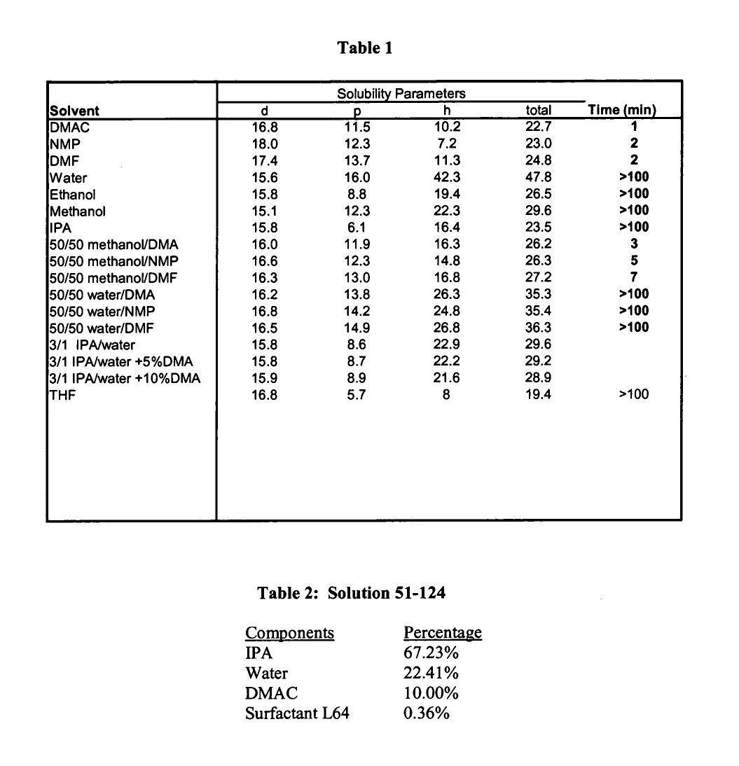

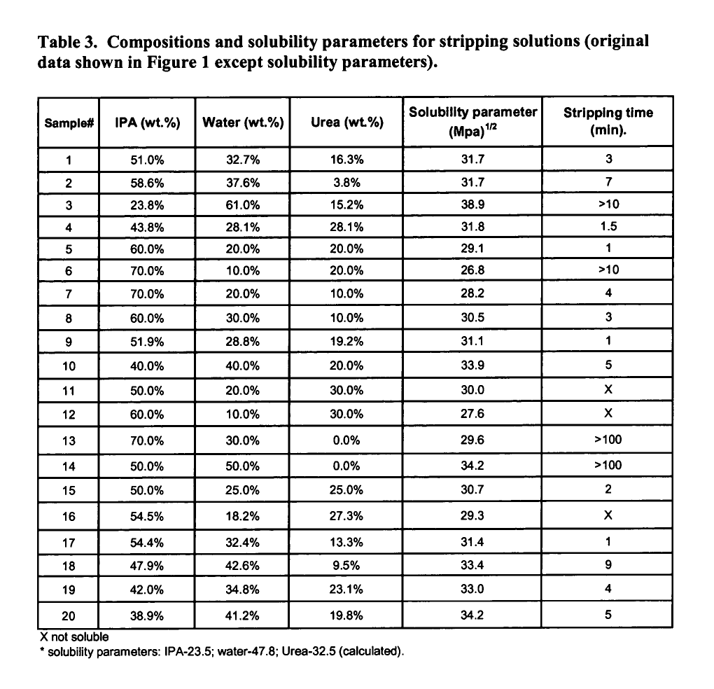

Solvents of the invention may be mixed with each other and with other compatible solvents such as, preferably, water, methanol, isopropanol (IPA), and combinations thereof. Solvents are mixed in a ratio, such that the mixtures has the solubility parameters outlined in FIG. 1 and FIG. 3.

Solvents may also be mixed with additives dissolved in the solution: These additives include, but are not limited to, surfactants, amines, and combinations thereof. Additives are typically included in small amounts to assist the stripping process.

Solid or Colloidal Dispersion

Optionally, solid or colloidal dispersions of solids are mixed with the solvents of the invention. Solid additives include, but are not limited to, particles with spherical or irregular shapes with very small particle size. Particles can be any form of silver powder, silica, alumina, and combinations thereof.

The following examples are offered to illustrate embodiments of the present invention, but should not be viewed as limiting the scope of the invention.

### EXAMPLES

### Example A

Solvent and Mixtures.

The stripping abilities of different solvents and mixtures were tested based on the time used to make CNT/PET become insulating after sonication (up to 100 minutes as maximum testing duration). Surface resistivity Rs change verses time was used to compare stripping rates. When sample becomes insulating, sample is examined under 1000× optical microscope (or tested under high voltage) to ensure that the sample is totally free of carbon nanotubes.

Results of some solvents are shown in Table 1. As can be seen, there is a basic trend in decreasing stripping ability as follows: DMAC>NMP >DMF_{—}>>50/50 water/NMP>methanol>50/50 water/DMF>50/50 water/DMAC>ethanol>IPA.

### Example B

Solvent Mixtures with Additive (Surfactant and Amine).

A sample was prepared from the composition of solution #51-124 (Table 2). This composition showed high selectivity, and was used to perform initial trials for circuit patterning. Additional patterning was performed using triethyl amine, which showed improved stripping rate. Stripping rates could also be improved by the addition of small amounts of silver powders and/or ZnO particles. These solvent mixtures with solid additives may be particles or colloid.

### Example C

Selective Circuit Patterning Using Stripping Solution #51-124.

A stripping solution with selectivity (#51-124) was used to develop samples of circuit patterning. One example used urea as an additive in the mixtures of water and alcohol (Table 2). With this mixture, other nitrogen containing material or polar molecules can be used.

Table 1 shows various solution compositions and their respective stripping capability. The stripping capability is measured as the time to completely strip off the CNT coating on a PET substrate (ST505) that has about 500 ohm/sq of sheet resistance. The sample was immersed in stripping solution and treated under sonication. Table 1 shows the phase diagram and the stripping time of each composition. The compositions falling into the circled areas of FIGS. 1 and 3 are the most preferred range. Their stripping time is in the range of 1-3 minutes. Table 3 provides calculated solubility parameters.

### Example D

Selectivity:

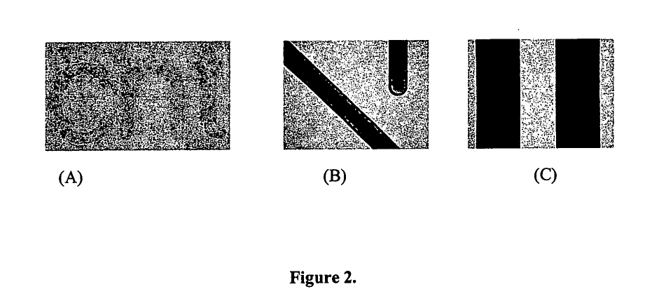

Stripping times were equal to or less than one minute to develop circuit patterning by selectively stripping off unwanted CNT. These samples had patterned binders onto the CNT conductive (FIG. 2). Patterning comprised CNT conductive pathway and insulative areas (stripped area). These examples include:

(A) Screen printed PVDF on CNT/PET;

(B) Photolithographed dry film resist on CNT/PET;

(C) Ink jetted polyethylene wax (hot melt ink) on CNT.

Binder protected CNT patterns are the conductive pathways. CNT in the unprotected area were selectively stripped off to be electrically insulating. The experiments show that these urea-containing solutions are highly selective in stripping CNT. There is no damage to the edges of the binder protected patterns. Results were better than solutions containing organic solvents such as DMA. Conventional stripping solutions, over exposure and development might cause edge erosion. With solutions of the invention, over exposure does not cause such a problem since urea, for example, is benign to most of the polymers.

FIG. 3 shows a phase diagram for the basic composition of urea containing solution for selective stripping (the values close to the dots—complete stripping time in minutes for CNT/PET at 500 ohm/sq; X—not soluble; the area in the circle is the most preferred compositions). Calculation of solubility parameters of urea and the solutions: Urea formula: H₂N—C(═O)—NH₂, MW=60, density 1.33. F value: C═O: 263; —NH₂: 226.6 (Cal.cm3)½ mol-1.

Hilderbrand solubility parameter:
δ=Vm^{ΣF}=(263+2*226.6)*1.33/60=15.87(cal/cm³)^{1/2}=32.46(MPa)^{1/2}

Mixture law: δm=Σδiφi φi−vol. %

Urea-containing solutions show high CNT stripping capability and selectivity, and can be used for patterning development. These stripping solutions can be used as a basis for further formulation. Other ingredients such as surfactants can also be added.

Other embodiments and uses of the invention will be apparent to those skilled in the art from consideration of the specification and practice of the invention disclosed herein. All references cited herein, including all U.S. and foreign patents and patent applications, are specifically and entirely hereby incorporated herein by reference. It is intended that the specification and examples be considered exemplary only, with the true scope and spirit of the invention indicated by the following claims.

1. A method of removing at least some CNTs of a CNT-coated substrate comprising:
applying a stripping solution to the CNT-coated substrate;
optionally, mechanically or chemically agitating the CNT-coated substrate to release the at least some CNTs; and
rinsing the CNT-coated substrate with a fluid to remove said at least some CNTs.

2. The method of claim 1, which selectively removes only some of the CNTs of the CNT-coated substrate.

3. The method of claim 2, which does not remove CNTs from one or more other surfaces of the CNT-coated substrate.

4. The method of claim 1, wherein the stripping solution comprises one or more of the chemicals selected from the group consisting of DMAC, NMP, DMF, methanol, ethanol and combinations thereof.

5. The method of claim 4, wherein the stripping solution comprises only DMAC.

6. The method of claim 4, wherein the stripping solution comprises only NMP.

7. The method of claim 4, wherein the stripping solution comprises only DMF.

8. The method of claim 4, wherein the stripping solution comprises 50/50 water/NMP.

9. The method of claim 4, wherein the stripping solution comprises only methanol.

10. The method of claim 4, wherein the stripping solution comprises 50/50 water/DMF.

11. The method of claim 4, wherein the stripping solution comprises 50/50 water/DMA.

12. The method of claim 4, wherein the stripping solution comprises only ethanol.

13. The method of claim 4, wherein the stripping solution comprises only IPA.

14. The method of claim 1, wherein the CNT-coated substrate is coated with SWNT.

15. The method of claim 1, wherein the at least some CNTs comprises substantially all CNTs of the CNT-coated substrate.

16. A substrate prepared by the method of claim 1.

17. A method of forming a carbon nanotube-patterned surface comprising:
applying a solution of carbon nanotubes to a substrate to form a film;
impregnating the film selectively with a binder;
applying a solvent to the film to remove film not impregnated with binder; and
forming a carbon-nanotube patterned surface on the substrate.

18. The method of claim 17, further comprising treating said substrate with mechanical or chemical agitation.

19. The method of claim 18, wherein mechanical agitation comprises ultrasonic vibration, spraying with a fluid, or both.

20. The method of claim 18, wherein chemical agitation comprises exposing said substrate to one or more chemical agents that encourage removal of film not impregnated with binder.

21. The method of claim 20, wherein the one or more chemical agents are selected from the group consisting of water, alcohols, acids, bases and combinations thereof.

22. A carbon nanotube patterned substrate prepared by the method of claim 17.

23. The substrate of claim 22 which is an electrical circuit.

24. A method for removing CNTs from a surface of a CNT-coated substrate comprising:
impregnating at least part of a surface of the CNT-coated substrate with a photoresist;
projecting a predetermined pattern onto the surface of the CNT-coated substrate to secure CNTs to the substrate with the photoresist; and
removing unsecured CNTs.

25. The method of claim 24, wherein the pattern is created by UV radiation.

26. The method of claim 24, wherein the photoresist is selected from the group consisting of UV-curable chemicals.

27. The method of claim 24, wherein the CNT coating of the substrate and the photoresist are applied simultaneously.

28. A substrate prepared by the method of claim 24, wherein at least some CNTs have been removed.

29. The substrate of claim 28, wherein substantially all CNTs have been removed.

30. The substrate of claim 28, which is transparent.
